(19) United States
(12) Patent Application Publication
(10) Pub. No.: US 2005/0221044 A1
(43) Pub. Date: Oct. 6, 2005

(54) Glass cutting method which does not involve breaking

(75) Inventors: Olivier Gaume, Levallois-Perret (FR); Serge Valladeau, Drancy (FR)

Correspondence Address: OBLON, SPIVAK, MCCLELLAND, MAIER & NEUSTADT, P.C., 1940 DUKE STREET, ALEXANDRIA, VA, 22314, US

(73) Assignee: SAINT-GOBAIN GLASS FRANCE, Courbevoie (FR)

(21) Appl. No.: 10/513,022

(22) PCT Filed: May 7, 2003
(86) PCT No.: PCT/FR03/01417

§ 371 Date: Apr. 26, 2005

(30) Foreign Application Priority Data
May 7, 2002 (FR) 02/05956

(51) Int. Cl. G09F 3/00

(52) U.S. Cl. 428/43; 428/192

(57) ABSTRACT

A method for cutting a glazing unit without applying a breaking force. The method applies a treatment to the glass sheet that generates stresses with a biaxial distribution, the stresses being such that the K factor is between 0.05 and 0.4 MPa·m^{1/2}; the K factor being defined by
K=[∫σ_{z}²·H(σ_{z})·dz]^{1/2}
in which z is a position in the thickness, σ_{z} is intensity of the approximately isotropic biaxial stress at the position z, H(σ_{z}) is equal to 1 if σ_{z} is greater than 0 and is equal to 0 if σ_{z} is less than or equal to 0, with the convention that extension is denoted by positive values and compression by negative values. A subcrack deeper than 10 μm is scored along the desired line of cutting, the subcrack reaching that region of the glazing in extension. The method allows cutting of glass, without breaking it, along curves with a small radius of curvature, or of glass strips of width similar to the thickness, or of frame shapes used as inserts in a flat field emission display.

The invention relates to a method of cutting a glazing unit without it being necessary to apply a breaking force.

A glass is usually cut according to the following successive steps:
scoring a subcrack along the desired line of cutting, then
application of a (breaking) force so that the subcrack propagates as a crack through the thickness of the glass, thereby breaking it as expected.

However, after a glass has been cut it may be desired to improve its mechanical strength, for example its edge bending strength. To do this, a chemical toughening (or tempering) treatment may be carried out on the cut glass, generally by immersing it in a bath of molten potassium nitrate. Chemically toughened glasses therefore have their definitive shape before the chemical toughening treatment and they are not intended to be cut after the toughening has been carried out.

WO 98/46537 teaches particular glass compositions obtained by chemical toughening (potassium ion exchange) for producing windows in the aeronautical field. No cutting is envisaged after the chemical toughening.

EP 793 132 teaches cells formed from a pair of glass plates having electrodes on their surface, and at least one of the plates of which has undergone a chemical toughening treatment. The glass, intended to be incorporated into such a cell, is chemically toughened, then notched and broken into as many individual elements as will be incorporated into the cell. The chemical toughening treatment is carried out here on a thickness of at most 20 μm. The above document teaches that, after having notched a glass, it is usually necessary to apply pressure in order to break it and that, in the case of a chemically toughened glass, if the chemically toughened layer is too thick it may be extremely difficult to break it. The object of EP 793 132 is to carry out a chemical toughening treatment allowing the glass to be broken in a conventional manner. To do this, glass having a maximum thickness of 2 mm is chemically treated over a maximum thickness of 20 μm.

EP 875 490 discloses a continuous process for producing glass hardened by chemical toughening. The glass must have a maximum thickness of 1.2 mm and it is toughened in less than two hours. The chemical toughening treatment is carried out over a maximum thickness of 30 μm. The glass may be wound. The glass may be covered with layers, for example metal layers, produced by sputtering, and may have an application as an LCD or DTR. The chemically treated glass may be cut into plates or sheets. That document does not teach the particular conditions for cutting the glass without breaking it.

EP 982 121 discloses three-layer structures, at least one of which, on the surface, is made of glass and includes notches. The notches may have a zero width. Preferably, the layer just below the notched glass is flexible (e.g., it is a polymer). Thus the trilayer has more flexibility thanks to the notches. The notched glass may have been chemically toughened. If the notch has a nonzero width, it may be filled with a polymer having a refractive index identical to that of the notched glass. The envisaged applications are: security card, windows for buildings, smart cards, photomasks. The notches may be left visible so as to have a mirror effect.

EP 964 112 teaches a panel comprising a glass sheet having, over part of its thickness, grooves arranged horizontally and parallel to one another. These cuts are preferably produced by a laser. That document does not teach the chemical toughening of the glass.

FR 1 598 242, FR 2 053 664 and FR 2 063 482 teach the chemical toughening in the presence of screens that protect certain areas from the toughening. The cut is then produced in these areas. This treatment necessarily generates an imbalance of the stresses in the thickness, compared with a thermally toughened pane without a screen. Thus, these glazing units are not in self-equilibrium in the thickness. Furthermore, a ribbon thus treated is not homogeneous and has to be cut in the areas protected by the screens. These documents do not therefore teach how to produce a glazing unit that can be cut, without breaking it after scoring, at whatever point on its surface, whereas this is the case for the glazing units according to the invention because of their homogeneity. In addition, the screens recommended by those documents impair the effect of the thermal toughening at the edges, just at the points where strengthening by the toughening treatment would in general be expected.

An unusual behavior of glass, when it is cut after having been treated in a certain way, has now been discovered.

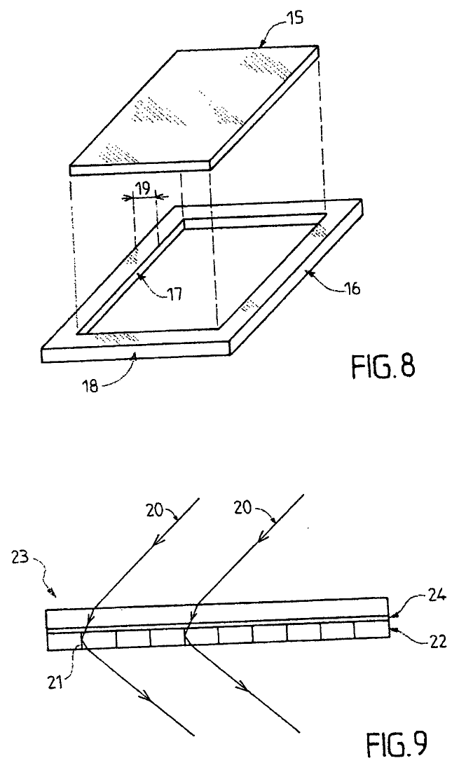

When the essential parameters of the invention are achieved, the crack caused by the scoring propagates all by itself through the treated glazing, that is to say without it being necessary to apply a breaking force. Within the scope of the present application, the term “glazing” has a very general sense, without any shape limitation, covering all glass-based articles and in general comprising two generally parallel main faces, and especially the frames shown in FIG. 8.

According to the invention, it has been discovered that a glass treated so as to have a K factor of between 0.05 and 0.4 MPa·m.^{1/2} could be cut without it being necessary to apply a breaking force, the K factor being defined by

$$K = {[ {\int }_{z} {σ}_{z}^{2} \cdot H ( {σ}_{z} ) \cdot ⅆ z ]}^{1 / 2}$$

in which z is a position in the thickness, σ_{z} is the intensity of the approximately isotropic biaxial stress at the position z, H(σ_{z}) is equal to 1 if σ_{z} is greater than 0 and is equal to 0 if σ_{z} is less than or equal to 0, with the convention that extension is denoted by positive values and compression by negative values.

In fact, for such a glass, the subcrack itself propagates as a crack passing through the thickness of the glass, even in the absence of a breaking force. It is necessary for the subcrack to reach that region of the glazing in extension and to be deeper than 10 μm. In particular, the invention allows the cutting, without breaking, of glass sheets of any thickness, especially less than 500 μm, but also greater than 1.2 mm and even greater than 2.6 mm, thicknesses that it is not usually known to cut directly by means of a laser in the case of a glazing unit outside the invention. The cutting according to the invention also generally results in an edge that does not cut one's hand, this being an advantage from the standpoint of safety. In general, the cutting without breaking according to the invention is carried out on glass having a thickness of less than or equal to 5.2 mm.

Thus, the invention relates to a method of cutting a glazing unit that includes a glass sheet having two main faces, said method not involving the application of a breaking force, said method comprising the following steps:
application of a treatment to the glass sheet that generates stresses and at least one region in compression and at least one region in extension, the distribution of the stresses being biaxial, approximately isotropic and self-balanced in its thickness, said stresses being such that the K factor is between 0.05 and 0.4 MPa·m^{1/2};
scoring a subcrack deeper than 10 μm along the desired line of cutting, said subcrack reaching that region of the glazing in extension.

The stresses giving the glass its property of being able to be cut without breaking may be conferred on any type of glass by a suitable treatment, and especially:
a chemical toughening treatment or
the production of at least one thin layer or
the subjection of the glass to approximately isotropic biaxial bending during the scoring operation.

The first two treatments mentioned above result intrinsically in an approximately isotropic biaxial stress distribution. These first two treatments also result in stresses that are residual after cutting. The third treatment (subjection to biaxial bending) does not result in residual stresses after cutting, since the flexural forces disappear as soon as the glass is broken.

The treatment gives the glass an approximately isotropic biaxial stress distribution, which means that the stresses are exerted in directions parallel to the glazing and, for a given depth, with approximately the same intensity in all directions parallel to the glazing. These biaxial stresses are generally isotropic in a plane parallel to the glazing. These stresses are self-balanced in the thickness of the glazing, which means that the extensional stresses balance out the compressive stresses, which also amounts to saying that ∫σ(z)dz=0 in which a(z) represents the stress at the position z in the thickness of the glazing. The invention makes it possible to produce a glazing unit that can be cut according to the invention at any point whatsoever. Such a glazing unit may have a large surface, especially greater than 10 cm, or even greater than 20 cm, or indeed greater than 50 cm or indeed greater than 1 m in all directions parallel to its main faces (the case of flat glazing).

Before said treatment, the glass may have no internal stress. It may especially be a float glass. The glass may be of any composition, and especially of the soda-lime type, or it may have one of the compositions described in FR 97/04508 or WO 96/11887.

If it is chosen to carry out the treatment by chemical toughening, the glass must contain an alkali metal oxide. This oxide may be Na₂O or Li₂O and be present in the glass in an amount, for example, from 1 to 20% by weight. The chemical toughening treatment consists in replacing the alkali metal ions initially in the glass with other, larger alkali metal ions. If the initial oxide is Na₂O, a chemical toughening by treatment with KNO₃ is applied, so as to at least partly replace Na⁺ ions with K⁺ ions. If the initial oxide is Li₂O, a chemical toughening by treatment with NaNO₃ or KNO₃ is applied, so as at least partly to replace Li+ ions with Na⁺ or K⁺ ions, depending on the case. In particular, if the treatment is a chemical toughening treatment, the glass cut according to the invention has a better edge strength. The toughening may therefore result in a K⁺ or Na⁺ ion concentration gradient perpendicular to at least one of the main faces and decreasing from said main face.

To measure the K factor in the glass, the technique of biasographe may be used. This technique is well known to those skilled in the art, and reference may in particular be made to the work “Photoelasticity of glass” by H. Aben and C. Guillemet, Springer-Verlag 1993, page 150.

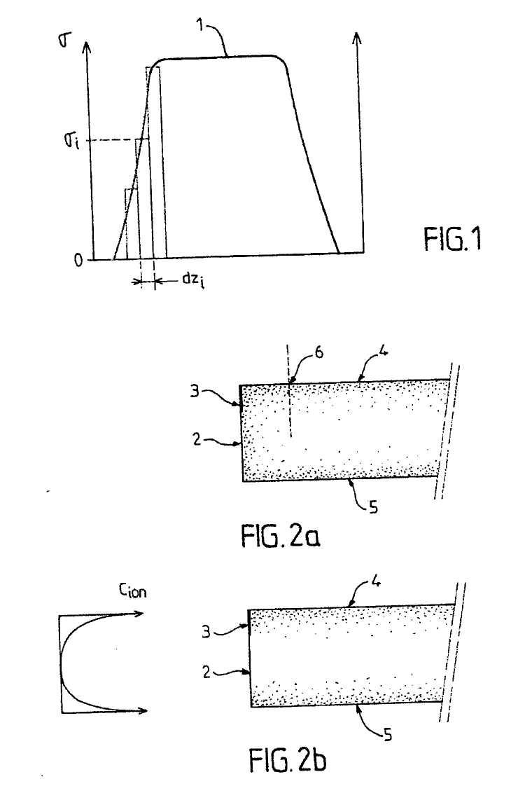

The technique of biasographe gives a stress intensity profile, such as for example curve (1) shown in FIG. 1, representing the change in the stress a as a function of the depth in the glass (the x-axis is perpendicular to the glazing). All the stresses ai corresponding to a thickness dzᵢ are therefore measured over the entire curve (1), the value of dzᵢ being, for example, 8 μm. In practice, the K factor is then determined from the formula:

$$K = {( {Σσ}_{i}^{2} \cdot {dz}_{i} )}^{1 / 2} .$$

The biasographe technique requires access to the edge of the glazing. To use this technique, it is preferable for the width of the glazing to be equal to at least five times its thickness. Other photoelasticity methods may also be used, such as a stratorefractometer.

To obtain a glazing unit having a K factor of between 0.05 and 0.4 MPa·m^{1/2} it may be made to undergo chemical toughening. This chemical toughening must be carried out for a long enough time and at a high enough temperature for the K factor to be between 0.05 and 0.4 MPa·m^{1/2}. By routine tests, a person skilled in the art may find the time and temperature allowing such values to be obtained. In general, the chemical toughening is carried out by immersing the glazing unit to be treated in a hot bath of the chosen salt (generally NaNO₃ or KNO₃). This bath contains the concentrated salt. The chemical toughening is generally carried out between 380° C. and 520° C., and in any manner at a temperature below the softening point of the glass to be treated. The chemical toughening causes ionic exchange at the surface of the treated glass over a depth which may possibly range up to, for example, 50 μm. This ionic exchange is the cause of alkali metal ion concentration gradients. In general, this gradient is characterized by a reduction in the concentration of ions provided by the chemical toughening (generally K⁺ or Na⁺) from the main face toward the core of the glazing. This gradient exists between the surface and, for example, a depth of at most 50 μm. This gradient is shown in FIG. 2 by dots whose density decreases on moving further towards the inside of the glazing. The depth of the gradient is exaggerated in the figures in order to aid comprehension.

The chemically toughened glazing units of the prior art, given the fact that they are not cut after the chemical toughening, have the same composition over their entire surface, including the edge. FIG. 2a) shows in cross section the edge of a glazing unit chemically treated after cutting. The cut gave rise to the edge (2). The scored line of the subcrack (3) is visible on the edge and shown in FIG. 2a) by a bolder line (it will be recalled that a subcrack is always visible on the cut edge of a glazing unit with the naked eye if the glazing is thick enough or with a microscope in the case of excessively thin glazing, for example with a thickness of less than 500 μm). The chemical toughening of the glazing after cutting gives rise to alkali metal ion exchange between the glazing and the toughening medium. This exchange created an alkali metal ion concentration gradient from the surface of the glazing toward the inside of the glazing, this gradient existing from the parallel main faces ((4) and (5) in FIG. 2) of the glazing and to a sufficient distance from the edges (including that denoted (2)), for example from the point (6) on the surface of a main face and perpendicular to this face toward the core of the glazing. This point (6) may generally be at least 1 mm from the edge. This gradient does not exist along the edge in a direction perpendicular to the main faces, but it does exist on the edge in a direction parallel to the main faces of the glazing and at a sufficient distance from said main faces.

FIG. 2b) shows a glazing unit according to the invention, which was cut after the chemical toughening treatment. It will be understood that, in this case, the edge (2) cut according to the invention has a composition that varies depending on whether one is close to or far from the parallel main faces of the glazing. The surface of the edge cut according to the invention has a surface concentration gradient of alkali metal ions between the main face in which the subcrack was formed and the core of the glazing. This is in fact the fundamental difference from a glass cut before being treated by chemical toughening (the case shown in FIG. 2a)) for which this gradient along the edge does not exist. In the case of the present invention, the edge cut according to the invention does have this gradient and has the mark of the subcrack, it being possible however, for this mark to be removed subsequently, for example by abrasion or polishing. Thus, the invention also relates to a glazing unit having such an edge with no subcrack visible.

If the chemical toughening is carried out in a potassium nitrate bath, the surface concentration of potassium ions is a maximum along the edge at the end of the edge, that is to say at the corner between the edge and the main face on which the subcrack was formed. This variation in the surface ion concentration Cᵢₒₙ along the edge is shown schematically by the curve on the left-hand side of FIG. 2b). However, this edge does not have a concentration gradient in a direction parallel to the main faces of the glazing (the faces denoted 4) and 5) of FIG. 2a)). The edge having the subcrack therefore does not have an alkali metal ion concentration in the direction perpendicular to said edge.

The treatment conferring the stresses on the glass may also be the application of at least one thin film. The film must be deposited so that it is in compression at the moment of scoring. This may in particular be achieved by hot deposition (generally at between 400 and 700° C.) of a film whose expansion coefficient is less than that of the substrate. The film is then put into compression during cooling. The cut is then made after the coated glass has returned to room temperature. The film may be produced in particular by sol-gel or screen printing or CVD processes. The film may also be produced at low temperature by the process of magnetron sputtering or plasma CVD, and especially when the film is made of silicon nitride. It is possible to check that the film is in compression, as it has a natural tendency to give the coated substrate convexity, seen from the side with the film.

The film has a thickness allowing the desired stress intensity factor to be obtained. In general, the film has a thickness ranging from 1 to 20 μm. Preferably, the film contains a stress ranging from 200 MPa to 5 GPa, for example about 300 MPa. A person skilled in the art will know how to measure the stress in a film on the glass. This stress in the film may especially be measured from the change in the curvature of the glass, or from the stress that it induces in the glass, this stress usually being evaluated by photoelasticity.

The film may especially be made of silicon nitride, silicon carbonitride, silicon carbide, silicon oxycarbide, silicon oxycarbonitride, titanium oxide, titanium nitride, titanium carbonitride, titanium carbide, titanium oxycarbide or titanium oxycarbo-nitride.

It is also possible to apply a film in compression on each side of the substrate. When the glass is coated only on one side with a film in compression, the scoring may be done on the side with the film. For the scoring, a force may be applied to the glazing that tends to reduce the convexity conferred on the coated glass by the film, but this is not essential. When the glass is coated on both its faces with a film in compression, the scoring may be done on one or other of the faces.

The treatment conferring the stress on the glass may also be the application of an approximately isotropic biaxial bending force. A suitable biaxial bending force may be applied by heating the two main faces of the glazing to different temperatures and by opposing the deformation that this temperature difference naturally tends to induce by applying a force to the glazing. The scoring is performed, and hence the breaking, as long as the temperature difference and the force opposing the deformation exist. In this case, the bending forces are generated by the combination, on the one hand, of the application of different temperatures to the main faces and, on the other hand, of forces opposing the deformation that the temperature difference induces.

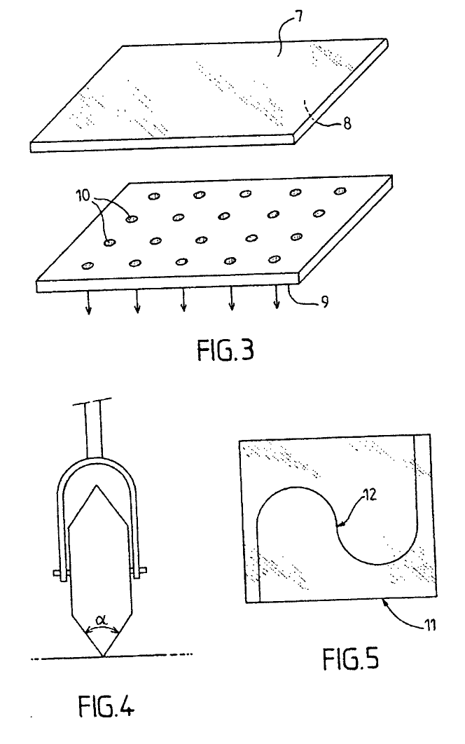

FIG. 3 illustrates one embodiment according to this principle. This figure shows a glazing unit having two main faces (7) and (8) and a plate (9) having a number of holes (10). The glazing unit may be pressed against the plate since it is sucked against it by suction being exerted through the holes. The plate is heated to a different temperature from the starting temperature of the glazing so that the face (8) has a different temperature from that of the face (7). The creation of this temperature difference between the two faces of the glazing is why stress is created in the glazing while it rests pressed against the plate. This is because if the glazing were left to assume its equilibrium shape, it would not contain any stress. If the face (8) is hotter than the face (7), it is the face (8) that is in compression as long as the glazing remains pressed. In this case, the scoring may be done on the face (7), that is to say the face in extension.

The subcrack on this face therefore immediately reaches the region in extension and a subcrack of very shallow depth, while still remaining deeper than 10 μm may be sufficient. If the face (8) is cooler than the face (7), it is the latter face that is in compression as long as the glazing remains pressed. In this case, the scoring may be done on the face (7), that is to say the face in compression, in which case, since the subcrack has to be deeper than the thickness in compression in order to reach the region in extension, it must be deeper than half the thickness of the glazing.

In the case of the application of a bending force, the scoring must be done while said force is being exerted.

The forces applied so as to generate the stress in the glass are much less than the conventional breaking forces. For example, for a glazing unit having a thickness ranging from 0.1 to 5.2 mm, these bending forces may be between 3 and 70 MPa, extends understood that the thinner the glazing the higher the force must be. In general, for glazing having a thickness ranging from 1 to 5.2 mm, these bending forces may be between 3 and 20 MPa. In fact, as soon as the scoring is done, the subcrack propagates right into the thickness of the glass and it would be possible to immediately stop the bending forces just after scoring without this having any influence on the breaking.

To cut the glass having a suitable K factor without breaking it, the surface of the glass is scored along a line corresponding to that of the desired cut. This scoring results in a subcrack (also called a blind crack by those skilled in the art). The scoring may especially be done using a scoring wheel or by a diamond or by laser. Usually, and more particularly for glazing having a thickness ranging from 1 to 3 mm, the subcrack has a depth of 100 to 1000 μm. Usually, the subcrack has a depth of between 10% and 20%, for example about 15%, of the glazing thickness.

When a scoring wheel or a diamond is used, the scoring is done with a load sufficient to obtain a sufficient depth of the subcrack, which must be able to propagate without the application of a breaking force. When a scoring wheel or a diamond is used, the scoring is preferably done under a cutting oil (also called “petrol” by those skilled in the art). When a scoring wheel is used, it is preferable to use a scoring wheel with a large angle, for example 145°. The angle of the scoring wheel is the angle α as shown in FIG. 4. For a given scoring wheel or diamond, it is also possible by routine tests to find a load suitable for the scoring. This is because an insufficient load results in no fracture, while an excessively high load results in an uncontrolled fracture, that is to say a fracture that does not always follow the line of scoring.

When the essential parameters of the invention have been achieved, the crack caused by the scoring propagates all by itself through the treated glazing, that is to say without it being necessary to apply a breaking force. It is possible to accelerate the propagation of the crack by at least one of the following means:
with water: a little water may be placed in the subcrack; to do this, it is possible, for example, to wet the glazing before cutting, wetting only that part (typically a few mm) of the glazing corresponding to the end of the scoring;
by increasing the scoring load at the end of scoring.

The scoring must result in a subcrack. The scoring may be carried out on a main face of the glazing that is in compression or, if it exists, on a main face of the glazing that is in extension. When the scoring is carried out on a main face in compression (especially in the case of a surface treated by chemical toughening or by a film in compression), the subcrack is deeper than the thickness in compression ec so as to reach the region in extension. Preferably, especially if the treatment is a chemical toughening treatment, the subcrack has a depth of 5 to 20 times the value of the thickness in compression e_{c}.

In the case of a chemical toughening treatment, the thickness in compression may be evaluated from the depth of ion exchange Pₑ, which may be determined

$$a ) either by {P}_{e} = \frac{\sqrt{π \times Mv \times ev \times Δ m}}{32 \times a \times mi}$$

in which:
a represents the initial molar % of alkali metal oxide in the glass (for example Na₂O or Li₂O);
mi represents the total initial mass (before toughening) of the glass in grams;
Mv represents the molar mass of the glass in g/mol;
Δm represents the rate of uptake of the glass during toughening in grams; and
ev represents the thickness of the glass in micrometers, Pₑ thus being obtained in micrometers;
b) or by a microprobe profile, in which case it is defined by the depth for which the content of ions provided by the toughening is equal to that of the glass matrix to within 5%.

In the case of a treatment by formation of a film, the thickness in compression is equal to the thickness of the film, provided that the film is in compression and that no external force deforms the glazing substantially.

In the case of a treatment by the application of bending forces, if the scoring is carried out on the side in compression, the thickness in compression is equal to one half of the thickness of the glazing. In the case of a treatment by the application of bending forces, if the scoring is carried out on the side in extension, the subcrack may be shallower, while still remaining greater than 10 μm.

The invention makes it possible in particular to cut a glass sheet having a thickness of at least 0.3 mm, or at least 0.7 mm, or at least 1.2 mm or greater than 1.5 mm or even at least 2.6 mm, without breaking it. In general, the glass sheet has a thickness of less than 20 mm, for example at most 5.2 mm. The glazing may in particular have a thickness ranging from 0.7 mm to 5.2 mm, for example 2.6 to 5.2 mm.

The cutting according to the invention starts by the scoring of a subcrack on the surface of a glass, and the propagation of a crack through the entire thickness of the inorganic part of the glazing that has undergone the cut is observed. In fact, in the case of a laminated glazing unit that is the association of at least two glass sheets placed on either side of a polymer interlayer, one of the glass sheets being treated according to the invention and scored according to the invention, it is clear that the crack propagates only through the sheet that was scored and not the other glass sheet lying on the other side of the polymer interlayer.

The invention also relates to a glazing unit comprising a glass sheet having two main faces and at least one edge, said glazing unit having a distribution of stresses through its thickness, said stresses being biaxial, approximately isotropic and self-balanced, and the K factor of which is between 0.05 and 0.4 MPa·m^{1/2}.

The invention makes it possible to produce cutting profiles that the prior art does not allow to be produced.

According to the invention, it is possible to cut glass along a curved line with a very small radius of curvature, and to do so even with a thick glass. At least at one point along the line of cutting, the radius of curvature may be less than 40 mm, or even less than 30 mm, or even less than 20 mm or even less than 10 mm or even less than 5 mm. In general, the radius of curvature is greater than 3 mm. Such radii of curvature of the cutting may be obtained for glazing with a thickness of even greater than 1 mm, or indeed greater than 2.6 mm. In general, to produce radii of curvature of less than 10 mm, it is preferable for the glazing to have a thickness of less than 5.2 mm, in particular, it is thus possible to cut magnetic recording disks, that is to say to make, simultaneously, their peripheral circular cut and their central circular hole.

According to the invention, it is possible to make a cut along a curved line changing in concavity, and even linking inverse concavities with very small radii of curvature, such as those that have just been given. FIG. 5 illustrates one form of cut produced on a glazing unit (11), said cut having a change of concavity at the point (12). Linked to the point (12) are two curves of different concavity. In FIG. 5, the curve on either side of the point (12) has the same radius of curvature in absolute value, which may be very small as already explained.

According to the invention, it is possible to cut the glass over a very small width. A glazing unit generally has a thickness, a width and a length (at least equal to the width). In general, the glazing to be cut according to the invention has an approximately constant thickness. In general, it is flat. According to the invention, the width of glazing cut may even be less than 1.5 times the thickness, and even less than 1.2 times the thickness, and even less than 1 times the thickness and even less than or equal to 0.7 times the thickness. In general, the width of glazing cut is greater than 0.1 times the thickness. Thus, the invention makes it possible in particular to produce glass strips of square or rectangular cross section having the width given above and especially a width of magnitude similar to that of the thickness or even less than that of the thickness.

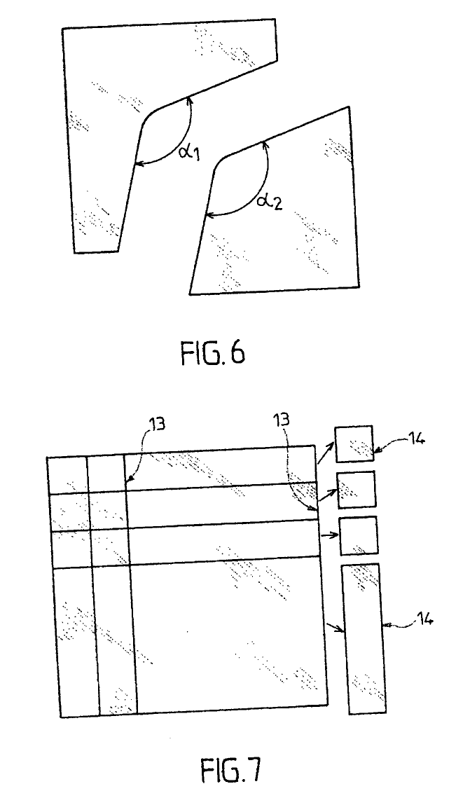

According to the invention, it is possible to cut a glazing unit along a line of cutting that includes an angle. This angle may, for example, range from 60° to 120° and in particular be 90°. Remarkably, the cut results in a piece having a concave angle α₁ and a piece having a convex angle α₂ being obtained (see FIG. 6). To do this the cut has not to be the result of intersection of two different lines of cutting that meet, said intersection forming the desired angle, the two lines of cutting being continued beyond their intersection. To produce the angle according to the invention, there are two options:
1) a hole may be made at the point chosen for the angle before the cutting and then the cutting is carried out by making two different scored lines that meet at the site of the hole, the hole possibly having a diameter of 0.2 to 2 mm for example; or
2) a hole is not made at the place chosen for the angle, rather a scored line is made that at every point satisfies the abovementioned condition as regards the radius of curvature, which must therefore be at least 3 mm. Thus, the angle is in fact a curve of very small radius of curvature. It is possible to repeat the scoring several times provided that the various scored lines meet so that their tangents coincide at the points of intersection.

If it is desired to do the scoring by hand, it may be preferable to produce a hole at the place desired for the angle. If the scoring is done by a machine, a hole need not be made prior to the scoring provided that the scoring complies with the minimum radius of curvature given above. With this type of machine, the tracing is generally carried out in one single step, that is to say the scoring object is placed once on the glass and does not leave it until the end of the scoring.

FIG. 6 shows two glazing pieces after the cutting according to the invention. It may be seen that the cut has a rounded angle of small radius of curvature producing, in the two cut parts, two angles that fit together perfectly. This angle was produced without forming a hole prior to the cutting. According to the prior art, it was known how to make 90° angles, but by the intersection of lines of cutting that cross each other, that is to say that continue after their point of intersection. FIG. 7 illustrates this way of cutting ordinary glass according to the prior art, with lines of cutting (13) traversing the entire surface of the glazing, and resulting in square or rectangular pieces (14). The angles of all the pieces cut in this way are convex, none of the cut pieces having a concave angle.

According to the invention, it is possible to cut and remove a full shape even from the inside of a glass plate without said cut intersecting the original external border of the glazing. Thus, a full shape, whose external border has the shape of the cut, is removed from the rest of the glazing, which then has an internal border having the shape of the cut and an external border remaining unchanged with respect to the original external border (before cutting). To do this, the scoring is carried out along a line that joins up with itself without intersecting with the external border of the glazing and resulting in the cutting, on the one hand, of a full shape and, on the other hand, of a holed shape, the external outline of the holed shape corresponding to the original external outline of the glazing, the internal outline of the holed shape corresponding to the external outline of the full shape. This full shape may be a circle or have a radius of curvature as already mentioned. FIG. 8 illustrates this possibility. In this figure, a full shape (15) has been cut from the inside of a plate, which then appears as a holed shape (16). The external outline of the full shape corresponds to the internal outline (17) of the holed shape. The external outline (18) of the holed shape is the same as the original plate before cutting.

The full shape may be a circle or may include a small radius of curvature, as already mentioned. The full shape may also include one or more angles as already mentioned, it being understood that these angles have to be made according to the abovementioned conditions, that is to say with the formation of a hole prior to the cutting or without the prior formation of a hole, but by the scoring complying with a minimum radius of curvature of 3 mm. Thus, a full shape may be cut with a polygonal outline. In particular, the polygonal shape may include three, four, five or six angles, or even more. Thus, it is possible to cut a full shape having the shape of a square or rectangle after having made a cut with four 90° angles (this is the case for the cut shape shown in FIG. 8). The holed shape therefore has the shape of a frame, said frame shape having an internal border of square or rectangular shape and an external border of square or rectangular shape. This frame also has a cross section of square or rectangular shape. The holed shape (or frame) thus obtained is especially applicable as an insert piece between two glazing units, such as in flat FED (field emission display) screens. The holed shape may have a very small edge width ((19) in FIG. 8), that is to say one corresponding to what was already mentioned as regards thin strips. The full shape may be separated from the holed shape, preferably by extraction from that side with the initial scoring. The full shape may generally be extracted by hand. To make extraction easier, especially for greater glazing thicknesses, a thermal extraction operation may also be carried out, which consists in heating (for example to between 90 and 220° C.) firstly the entire cut glazing, but for which the full shape and the holed shape have not yet been separated, and then secondly the central part of the glazing comprising the full shape to be extracted is cooled. The contraction caused by the cooling allows the full shape to be more easily extracted.

The cutting according to the invention may be carried out by scoring the surface of a glass sheet treated in accordance with the invention (chemical, film, or bending treatment), said sheet forming part of a laminated glazing unit. In this case, the crack caused by the scoring propagates through the thickness of the treated sheet and stops at the polymer interlayer usually placed between the sheets of a laminated glazing unit. In this way, a multitude of parallel linear cracks may be produced through the treated sheet of the laminated glazing unit, passing through said sheet as far as the polymer interlayer. The cracks thus created act as mirrors for light passing through the glazing. The aesthetically attractive glazing thus obtained may serve as a light deflector. FIG. 9 illustrates this application. It shows that the light rays (20) are reflected at the interfaces (21) of the cracks created in accordance with the invention through the treated sheet (22) of the laminated glazing unit (23) comprising the combination of two glass sheets separated by a polymer layer (24). In this application, the cracks may be separated from one another by a distance of, for example, 2 mm to 10 mm. In general, it is desirable for the distance between two cracks to represent 40 to 80% of the thickness of the cracked sheet.

Of course, it is also possible to carry out conventional cutting, that is to say passing through the entire surface of the glazing, in order to cut square or rectangular shapes. Pieces of this type may serve as protective glazing for LCD (liquid-crystal display) cells.

The present invention, particularly when it involves a chemical toughening treatment, is very beneficial for the cutting of glazing in the electronic field. This chemical toughening technique is particularly applicable to glass capable of ion exchange, as is the case in electronics for glass having in particular a high strain point, for example CS77 glass sold by Saint-Gobain Glass France. The composition of such glass is described, for example, in EP 0 914 299. The cutting technique is therefore applicable in lines for the manufacture of accessories for electronics (such as spacers or inserts), of screens (plasma, LCD, TFT, FED screen) and of field emission displays, and in lines for manufacturing vacuum glazing. The use of chemical toughening gives the edges, especially the cut edges, high mechanical strength. With the cutting techniques of the prior art, it is necessary for the components to be brought into contact with the surface of the glass and to be held thereon, for the scoring and/or breaking, in order to cut the glass. This is a drawback if a surface of the glass has already received printing, as any contact with this printing may damage it. Thanks to the technique according to the invention, and more particularly when it employs chemical toughening, it is therefore possible to print the glass after the stress-generating treatment and then to cut it with the minimum of contact with components. In particular, it is therefore possible to produce a motherglass, to print patterns on the surface and then to carry out the manufacturing cycles in order only thereafter to cut each screen (telephone, palmtop or portable computer screen).

All the examples start with the chemical toughening of a glass plate, produced as follows, the essential parameters of said toughening (time and temperature) being given in table 1. The starting glasses used were the following:
CS77: glass sold by Saint-Gobain Glass France;
Px: glass of the PLANILUX brand sold by Saint-Gobain Glass France;
C0211: glass sold by Corning.
   Chemical Toughening for the Examples

A flat glass with the dimensions 300×200×e mm was taken, “e” representing the thickness that was toughened in a potassium nitrate bath at a temperature T for a time “t”. The treatments produced core stresses in the sheet.

Cutting Principle for the Examples

The glass plates were cut, using a diamond or a scoring wheel, into various cut shapes corresponding to various applications. The cuts using a scoring wheel were all made according to the principle below. The scoring was done with a scoring wheel of the VITRUM brand sold by Adler, said scoring wheel having an angle of 145° and a diameter of 5 mm with cutting fluid and with a load so that the subcrack is deeper than the exchange depth Pₑ. For the examples illustrating the invention, it was noticed that the subcrack propagated through the entire thickness of the glass without it being necessary to apply a breaking force (see the “propagation” line in table 1). In certain cases, the propagation was initiated at the end of the scored line by adding water, which penetrated by capillary effect into the subcrack. In other cases, the propagation was initiated by increasing the load at the end of the scored line.

For all the examples, the K factor in the glass was measured by a biasographe on glass strips 10 mm in width, except in the case of examples 5 and 6 for which the glass strips were 3 mm in width.

In table 1, the following expressions and abbreviations are used:
Pₑ: ion exchange depth;
Δ load: increase in load;
Propagation and type: it was judged whether the crack propagation proceeded correctly (guided propagation) or whether it was uncontrolled, which means that the glass does not break along the line of scoring, or whether it does not occur, which means that in the end the glass has not broken.

### EXAMPLES 1 AND 2

### Frames

Before the chemical toughening treatment, four holes 1 mm in diameter were produced in the corners of the plate with a diamond drill bit, said holes being placed 4 mm from the edges of said plate. After the chemical toughening treatment, the plate was cut along straight lines parallel to the edges of the plate and between the holes, so as to draw a frame. The glass rectangle between the holes could be extracted so as to recover a frame (see FIG. 8).

### EXAMPLE 3

### Daylight Reflection

A laminated glazing unit was produced with, on the one hand, the chemically treated plate and, on the other hand, a pane of ordinary soda-lime glass (not chemically treated) 2 mm in thickness, placing between them, in the conventional manner, a film of polyvinyl butyral (PVB).

After one end of the glazing unit had been immersed in water (to about 5 mm), a first series of straight and parallel scored lines was produced by the scoring wheel on that side of the glazing that was chemically toughened, said scored lines being separated from one another by 8 mm and finishing at the edge immersed in water. The water plays its role by initiating the propagation of each crack. A second series of scored lines was then produced, between the scored lines of the first series, so that in the end the plate had scored lines approximately every 4 mm. It was noted that all the cracks caused by the scored lines propagated as far as the PVB film, that is to say they passed through the entire thickness of the chemically toughened glass pane. The glazing unit could then act as a reflector for light passing through it, thanks to the mirror effect of each of the cracks (see FIG. 9).

### EXAMPLE 4

### Cutting A Circle

A circle 60 mm in diameter was cut in the chemically toughened glass using a scoring wheel of the VITRUM brand sold by Adler, said scoring wheel having an angle of 145° and a diameter of 5 mm and said scoring wheel being mounted on a circular glass cutter with a handle, having the reference Bohle 530.0 section 1.19. The glass disk could be extracted by thermal extraction without either the disk or the rest of the plate breaking.

### EXAMPLE 5

### Cutting Film Glass

Using a diamond, a glass sheet 300 μm in thickness was cut after it had been chemically toughened, without initiation, either with water or by a load increase. The cut is made easily along the scored line without uncontrolled breaking. The K factor in the glass was measured by a biasographe on strips 3 mm in width.

### EXAMPLE 6

### Comparative Example

The procedure was as in the case of example 5, except that the chemical toughening was carried out so that the K factor reached the value mentioned in table 1.

### EXAMPLES 7 TO 9

### Comparative Examples

The procedure was as in the case of example 2, except that the chemical toughening was carried out so that the K factor reached the value mentioned in table 1.

TABLE 1

| | Example No. | | | | | | | |
|---|---|---|---|---|---|---|---|---|
| | 1 and 4 | 2 | 3 | 5 | 6 (comp.) | 7 (comp.) | 8 (comp.) | 9 (comp.) |
| Glass type | CS77 | Px | Px | C0211 | C0211 | Px | Px | Px |
| before | | | | | | | | |
| treatment | | | | | | | | |
| Toughening | 15 h | 8 h | 13 h | 2 h | 3 h | | 72 h | 9 days |
| parameters (T | 490° C. | 490° C. | 490° C. | 460° C. | 460° C. | — | 490° C. | 460° C. |
| and t) | | | | | | | | |
| Glass | 1.1 | 1.6 | 2.85 | 0.3 | 0.3 | 1.6 | 1.6 | 3.85 |
| thickness | | | | | | | | |
| (mm) | | | | | | | | |
| K (MPa · m^{1/2}) | 0.19 | 0.26 | 0.24 | 0.38 | 0.42 | 0.01 | 0.52 | 0.52 |
| Pₑ (μm) | 27 | 41 | 51 | 17 | 20 | 0 | 122 | 123 |
| Scoring wheel | 3 | 3.7 | 4.0 | Uncontrolled | Uncontrolled | 4 | 5.5-6 | 3 to 6 |
| load (kg) | | | | | | | | |
| Subcrack | 170 | 395 | 360 | >30 | >30 | <550 | 400 | 430 |
| depth (μm) | | | | | | | | |
| Initiation? | Water | Δ load of | Water | No | No | Water | No | Δ load of |
| | | 0.5 kg | | | | | | 0.7 kg |
| Propagation | Guided | Guided | Guided | Guided | Uncontrolled | No propagation | No propagation | No propagation |
| and type? | propagation | propagation | propagation | propagation | propagation | | | |

1-31. (canceled)

32. A method of cutting a glazing unit that includes a glass sheet having two main faces, said method not involving application of a breaking force, said method comprising:
applying a treatment to the glass sheet that generates stresses and at least one region in compression and at least one region in extension, distribution of the stresses being biaxial, approximately isotropic and self-balanced in its thickness, said stresses being such that K factor is between 0.05 and 0.4 MPa·m^{1/2}, said K factor being defined by
$$K = {[ {\int }_{z} {σ}_{z}^{2} \cdot H ( {σ}_{z} ) \cdot ⅆ z ]}^{1 / 2}$$
in which z is a position in the thickness, σ_{z} is intensity of the approximately isotropic biaxial stress at the position z, H(σ_{z}) is equal to 1 if σ_{z} is greater than 0 and is equal to 0 if σ_{z} is less than or equal to 0, with a convention that extension is denoted by positive values and compression by negative values; and
scoring a subcrack deeper than 10 μm along a desired line of cutting of the treated glass sheet, said subcrack reaching the at least one region of the glazing in extension.

33. The method as claimed in claim 32, wherein, before applying the treatment, the glass sheet contains an alkali metal oxide and the treatment is a chemical toughening treatment.

34. The method as claimed in claim 33, wherein the chemical toughening results in a K⁺ or Na⁺ ion gradient perpendicular to at least one of the two main faces of the glass sheet and decreasing from said at least one main face.

35. The method as claimed in claim 33, wherein the chemical toughening results in ionic exchange over a depth of at most 50 μm.

36. The method as claimed in claim 32, wherein the treatment includes application by deposition of a film in compression.

37. The method as claimed in claim 36, wherein the film has a thickness ranging from 1 to 20 μm.

38. The method as claimed in claim 37, wherein the film contains a stress ranging from 200 MPa to 5 GPa.

39. The method as claimed in claim 32, wherein the treatment includes application of approximately isotropic biaxial bending forces.

40. The method as claimed in claim 39, wherein the bending forces are generated by a combination of applying different temperatures to the two main faces and of forces that oppose a deformation that the different temperatures induce.

41. The method as claimed in claim 39, wherein the bending forces are between 3 and 20 MPa.

42. The method as claimed in claim 41, wherein the glazing has a thickness ranging from 0.7 to 5.2 mm.

43. The method as claimed in claim 42, wherein the glazing has a thickness ranging from 2.6 to 5.2 mm.

44. The method as claimed in claim 32, wherein the scoring is carried out on a main face in compression and produces a subcrack that passes through the at least one region in compression to reach the at least one region in extension.

45. The method as claimed in claim 32, wherein the scoring is carried out on a main face in extension.

46. The method as claimed in claim 32, wherein the scoring is carried out along a line that joins up with itself without intersecting an external border of the glazing and resulting in cutting of a full shape and of a holed shape, an external outline of the holed shape corresponding to an original external outline of the glazing, an internal outline of the holed shape corresponding to the external outline of the full shape.

47. The method as claimed in claim 32, wherein the scoring is carried out along a line having, at at least one point, a radius of curvature of less than 5 mm.

48. A glazing unit comprising:
a glass sheet including two main faces and at least one edge, said glazing unit having a distribution of stresses in its thickness, said stresses being biaxial, approximately isotropic and self-balanced, and K factor of which is between 0.05 and 0.4 MPa·m^{1/2}, said K factor being defined by
$$K = {[ {\int }_{z} {σ}_{z}^{2} \cdot H ( {σ}_{z} ) \cdot ⅆ z ]}^{1 / 2}$$
in which z is a position in the thickness, σ_{z} is stress at the position z, H(σ_{z}) is equal to 1 if σ_{z} is greater than 0 and is equal to 0 if σ_{z} is less than or equal to 0, with a convention that extension is denoted by positive values and compression by negative values.

49. The glazing unit as claimed in claim 48, wherein the glazing unit has an alkali metal ion gradient perpendicular to at least one of the two main faces and decreasing from said at least one main face.

50. The glazing unit as claimed in claim 49, wherein the gradient perpendicular to at least one of the two main faces exists at a surface of at least one edge.

51. The glazing unit as claimed in claim 50, wherein the at least one edge has a scored line of a cutting subcrack.

52. The glazing unit as claimed in claim 48, wherein the at least one edge has no alkali metal ion gradient in a direction perpendicular to said edge.

53. The glazing unit as claimed in claim 48, wherein the glazing unit has a thickness ranging from 0.7 to 5.2 mm.

54. The glazing unit as claimed in claim 48, wherein the glazing unit has a thickness ranging from 2.6 to 5.2 mm.

55. The glazing unit as claimed in claim 48, wherein one of its borders has, at at least one point, a radius of curvature of less than 5 mm.

56. The glazing unit as claimed in claim 48, at least partly in a form of a strip with a square or rectangular cross section having a width of less than 1.5 times its thickness.

57. The glazing unit as claimed in claim 56, having at least partly a width of less than 1 times its thickness.

58. The glazing unit as claimed in claim 48, having a frame shape with a square or rectangular cross section, said frame shape having an internal border of square or rectangular shape and an external border of square or rectangular shape.

59. A flat field emission display, including an insert comprising a glazing unit of claim 58.

60. A laminated glazing unit, one of the glass sheets of which is a glazing unit as claimed in claim 48 and includes a multitude of parallel linear cracks passing through it as far as a polymer interlayer.

61. The glazing unit as claimed in claim 60, wherein the cracks are separated from one another by a distance of 2 mm to 10 mm.

62. The glazing unit as claimed in claim 60, wherein the distance between two cracks represents 40 to 80% of the thickness of the cracked sheet.
